(19) United States
(12) Patent Application Publication
(10) Pub. No.: US 2026/0180631 A1
(43) Pub. Date: Jun. 25, 2026

(54) ANTENNA INTEGRATED WITH FILTER

(71) Applicant: QUALCOMM Incorporated, San Diego, CA (US)

(72) Inventors: Manfred STADLER, Seiersberg (AT); Edgar Konrad SCHMIDHAMMER, Stein an der Traun (DE)

(21) Appl. No.: 18/988,737

(22) Filed: Dec. 19, 2024

(51) Int. Cl. H04B 7/0452; H01Q 21/00

(52) U.S. Cl. CPC H04B 7/0452; H01Q 21/0068

(57) ABSTRACT

An integrated antenna-array-and-filter is provided that includes a plurality of resonators coupled to an input port of a dielectric waveguide network. At least one antenna couples to an output port of the dielectric waveguide network. The plurality of resonators is configured to provide a plurality of poles in a filter frequency response of the integrated antenna-array-and-filter. The dielectric waveguide network and the at least one antenna are configured to provide at least one final pole in the filter frequency response.

### TECHNICAL FIELD

The present application relates generally to antennas, and more particularly to an antenna that functions as part of a filter.

### BACKGROUND

A gNobe B (gNB) provides wireless connectivity between a user equipment (UE) and the core network. As telecommunications standards have evolved, the capabilities of the gNB have evolved as well. For example, in the Fifth Generation New Radio (5G NR) protocol, a gNB may have various sub-arrays of antennas to allow the gNB to perform massive multi-in-multiple-out (MMIMO) signaling. In the MMIMO signaling path to a sub-array of antennas, an amplified radio frequency (RF) signal passes through a bandpass filter to filter out unwanted frequencies from the transmitted signal. The bandpass filter couples through a transmission line to the antenna sub-array.

To prevent unwanted reflections, the bandpass filter and the antenna sub-array are both impedance-matched to the characteristic impedance of the transmission line. As a result, a quality factor Q for the antennas typically needs to be relatively low (e.g., <<10) with minimal variation of the real part of the impedance across the operating bandwidth. Not only is the antenna design thus restricted, but the coupling of the bandpass filter through the transmission line to the antenna sub-array introduces insertion loss.

### SUMMARY

In accordance with an aspect of the disclosure, an integrated antenna-array-and-filter is provided that includes: a dielectric waveguide network; a first plurality of dielectric resonators coupled to a dielectric waveguide network; and a plurality of antennas coupled to the dielectric waveguide network, wherein the dielectric waveguide network and the plurality of antennas are configured to function as a resonator providing at least one pole in a filter frequency response of the integrated antenna-array-and-filter, and wherein the first plurality of dielectric resonators is configured to provide a remaining plurality of poles in the filter frequency response.

In accordance with another aspect of the disclosure, a method of transmitting is provided that includes: passing a first RF signal through a first plurality of dielectric resonators to generate a plurality of poles in a filter response of an integrated antenna-array-and-filter; and generating at least one remaining pole in the filter response by coupling the first RF signal from the first plurality of dielectric resonators through a first dielectric waveguide to a first antenna and transmitting the first RF signal from the first antenna.

Finally, in accordance with yet another aspect of the disclosure, an integrated antenna-array-and-filter is provided that includes: a plurality of dielectric resonators; a first antenna; and a dielectric waveguide coupled between the plurality of dielectric resonators and the first antenna.

These and other advantageous features may be better appreciated through the following detailed description.

### BRIEF DESCRIPTION OF THE DRAWINGS

FIG. 1 is a high-level diagram of an example integrated antenna-array-and-filter in accordance with an aspect of the disclosure.

FIG. 2 is a side view of an example integrated antenna-array-and-filter in accordance with an aspect of the disclosure.

FIG. 3 is a top view of an antenna structure and a portion of a corresponding dielectric waveguide network for the integrated antenna-array-and-filter of FIG. 1 in accordance with an aspect of the disclosure.

FIG. 4 is a bottom view of the integrated antenna-array-and-filter of FIG. 1 in accordance with an aspect of the disclosure.

FIG. 5 is a top view of an antenna array module including a plurality of integrated antenna-array-and-filters in accordance with an aspect of the disclosure.

FIG. 6 is a block diagram of a wireless communication device including an integrated antenna-array-and-filter in accordance with an aspect of the disclosure.

FIG. 7 is a flowchart for a method of operation for an integrated antenna-array-and-filter in accordance with an aspect of the disclosure.

Implementations of the present disclosure and their advantages are best understood by referring to the detailed description that follows. It should be appreciated that like reference numerals are used to identify like elements illustrated in one or more of the figures.

### DETAILED DESCRIPTION

A “filtenna” (antenna integrated with a filter) is disclosed that loosens the design restraints on the antenna design and lowers the insertion loss as compared to a traditional combination of a 50-ohm-matched antenna(s) coupled through a transmission line to a separate filter. In the antenna design disclosed herein, the antennas are an integral part of a multi-pole filter, they are not separate or distinct from the multi-pole filter. Moreover, because antennas no longer need to be matched to a characteristic impedance of a transmission line such as 50, the antennas no longer need to have a low quality factor but instead can have an advantageously higher quality factor (e.g., a quality factor of twenty or higher). To provide these advantages, a plurality of n−1 resonators (e.g., ceramic resonators) providing a plurality of n−1 poles couple through an input port to a dielectric waveguide network and from the dielectric waveguide network to a plurality of antennas, wherein n is a plural integer designating the number of poles in the filter frequency response for the filtenna. The antennas and the dielectric waveguide network provide the remaining pole to complete the filter in combination with the plurality of dielectric resonators. The filter may thus be a dielectric waveguide filter formed by the plurality of n−1 resonators, the dielectric waveguide network, and the antennas.

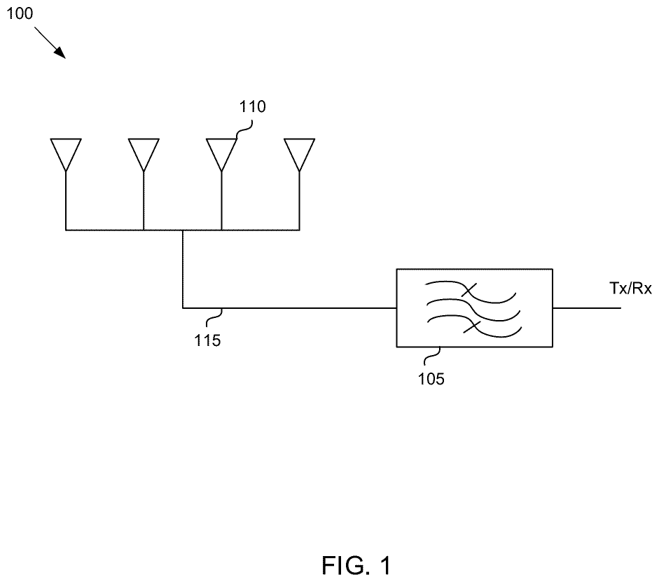

An example filtenna 100 is shown in a high-level representation in FIG. 1. A plurality of (n−1) dielectric resonators 105 function to generate n−1 poles in the filter frequency response (e.g., a bandpass response) of the filtenna 100 for either a receive or a transmit RF signal, where n is the plural integer discussed above. An array of antennas 110 are designed in conjunction with a dielectric waveguide network 115 coupling the antennas 110 to the dielectric resonators 105 to provide a final nth pole in the frequency response (e.g., the S11 scattering parameter) of the filtenna 100. The antennas 110 are thus an integral part of the filter frequency response such that neither the dielectric resonators 105 nor the antennas 110 will provide the desired filter performance when operated alone. But in combination, the filtenna 100 provides the desired performance such as measured by the filter frequency response, antenna gain, and insertion loss. Moreover, there is no need for the dielectric waveguide network 115 to have an impedance of 50Ω nor do the antennas 110 need to be matched to such an impedance because the dielectric waveguide network 115 and the antennas 110 are functioning as part of the filter for the filtenna 100. The following discussion will be directed to an example implementation in which the number n of poles is five without loss of generality. The dielectric resonators 105 would thus be designed to introduce four poles into the filter frequency response (the S11 scattering parameter) of the filtenna 100. The antennas 110 in conjunction with the dielectric waveguide network 115 provide the remaining pole for the frequency response.

Since the antennas 110 no longer need to be matched to a transmission line impedance, their design is simplified such that the antennas 110 may be designed for a relatively-high-quality factor such as twenty or greater. An integrated antenna-array-and-filter (filtenna) example will now be discussed in more detail. The following discussion will be directed to an integrated antenna-array-and-filter for a MMIMO base station (gNB), but it will be appreciated that the resulting filtenna may be incorporated into any suitable transceiver. Some examples include a transceiver in a small cell network.

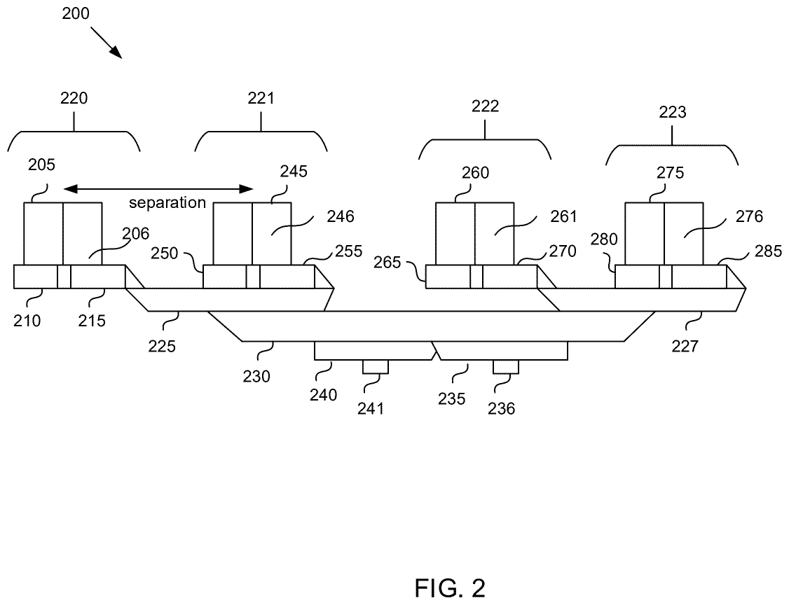

An example filtenna 200 is shown in a side-view in FIG. 2 that includes four rectangular dielectric antennas 205, 245, 260, and 275 and four substantially rectangular dielectric base plates 210, 250, 265, and 280. The four rectangular dielectric antennas 205, 245, 260, and 275 are substantially identical. Similarly, the four rectangular dielectric base plates 210, 250, 265, and 280 are substantially identical. Each antenna extends from a corresponding one of the base plates. In particular, the antenna 205 extends orthogonally from a plane defined by the base plate 210. Similarly, the antenna 245 extends orthogonally from a plane defined by the base plate 250 whereas the antenna 260 extends orthogonally from a plane defined by the base plate 265. Finally, the antenna 275 extends orthogonally from a plane formed by the base plate 280.

Each base plate has a substantially rectangular shape such that each base plate may be deemed to have four orthogonal faces. Each orthogonal face is aligned to be parallel to a corresponding orthogonal face of the antenna coupled to the baseplate. A dielectric feed that couples to an orthogonal face of a baseplate will thus also couple to the orthogonal face of the corresponding antenna. To transmit and receive two orthogonal polarizations, two orthogonal planar faces of each antenna's baseplate couple to respective dielectric feeds. Since there are four antennas 205, 245, 260, and 275, there are four pairs of dielectric feeds. Within each pair of dielectric feeds, a first dielectric feed contacts a first face of the corresponding antenna's baseplate. Similarly, a second dielectric feed contacts a second face of the corresponding antenna's baseplate. Due to the side view of FIG. 2, each second dielectric feed is not shown as it is shadowed by the corresponding first dielectric feed. In particular, a first dielectric feed 215 excites a first planar face 206 of the antenna 205. Similarly, a first dielectric feed 255 excites a first planar face 246 of the antenna 245. In the same fashion, a first dielectric feed 270 excites a first planar face 261 of the antenna 260. Finally, a first dielectric feed 285 excites a first planar face 276 of the antenna 275. The collection of each rectangular dielectric resonator antenna, the corresponding dielectric base plate, and the corresponding dielectric feeds form what is denoted herein as an antenna structure. There are four antenna structures 220, 221, 222, and 223 in the filtenna 200. However, it will be appreciated that the filtenna 200 may be readily extended such as through a doubling to form a linear array of eight antenna structures or such as through a quadrupling to form a linear array of sixteen antenna structures. Similarly, fewer antenna structures, for example two antenna structures, may be implemented.

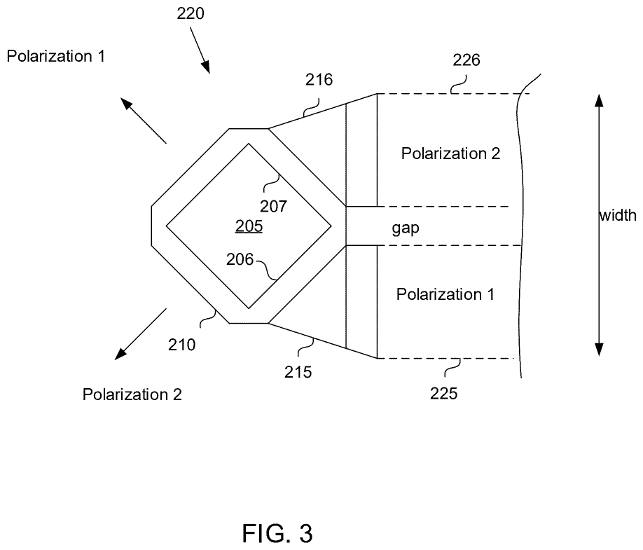

The electromagnetic coupling between each pair of dielectric feeds and the corresponding faces of the rectangular dielectric resonator antenna may be better appreciated with a consideration of FIG. 3, which illustrates a top view of the antenna structure 220. The remaining antenna structures are analogous. The first dielectric feed 215 is adjacent to the first planar face 206 of the rectangular dielectric resonator antenna 205. Similarly, a second dielectric feed 216 is adjacent to a second planar face 207 of the rectangular dielectric resonator antenna 205. The first planar face 206 is orthogonal to and adjacent to the second planar face 207. Due to this orthogonality, the coupling from the rectangular dielectric resonator antenna 205 by the first dielectric feed 215 transmits (or receives) an RF signal having a first linear polarization that is orthogonal to a second linear polarization excited by the second dielectric feed 216. The dielectric base plate 210 is substantially square shaped but other shapes may be used in alternative implementations. The remaining dielectric base plates 250, 265, and 280 are shaped analogously. It will be appreciated that other types of polarizations such as circular or elliptical polarizations may be excited by alternative implementations of a filtenna.

With reference to FIG. 2 in conjunction with FIG. 3, it may be seen that each dielectric feed is in turn fed by an underlying dielectric waveguide. These solid dielectric waveguides are denoted herein as upper dielectric waveguides to distinguish them from a pair of lower dielectric waveguides as will be explained further herein. In the following discussion, it will be assumed that each upper and lower dielectric waveguide is a rectangular dielectric waveguide, but it will be appreciated that other types of dielectric waveguides such as circular dielectric waveguides may be used in alternative implementations. An upper surface at an end of each upper dielectric waveguide contacts a lower surface of the corresponding dielectric feed to form an electromagnetic coupling. For example, a lower surface of the first dielectric feed 215 of the antenna structure 220 contacts an upper surface of a first end of a first upper dielectric waveguide 225. To assist in the coupling to the first dielectric feed 215, a first end of the first upper waveguide 225 is beveled so as to extend from a lower planar surface of the first upper waveguide 225 to an upper surface of first upper waveguide 225 that abuts a lower surface of the corresponding first dielectric feed 215. The remaining ends of the upper rectangular waveguides are beveled in an analogous fashion. The first dielectric feed 215 may be deemed to have a distal end that abuts the face 206 of the rectangular dielectric resonator antenna 205. A remaining proximal end of the first dielectric feed 215 is beveled to extend from an upper surface of the first dielectric feed 215 to a lower surface of the first dielectric feed 215. The proximal ends of the remaining dielectric feeds are beveled in an analogous fashion.

Analogous to the first end of the first upper dielectric waveguide 225, an upper surface of a second end of the first upper dielectric waveguide 225 contacts a lower surface of the first dielectric feed 255 of the antenna structure 221. In the side view of FIG. 2, the first upper dielectric waveguide 225 shadows a second upper dielectric waveguide 226 that is partially shown in FIG. 3. Similarly, a third upper dielectric waveguide 227 shadows a fourth upper dielectric waveguide (not illustrated).

The second upper dielectric waveguide 226 extends between the second dielectric feed 216 of the antenna structure 220 and a second dielectric feed (not illustrated) for the antenna structure 221. The third upper dielectric waveguide 227 extends between the first dielectric feed 270 of the antenna structure 222 and the first dielectric feed 285 of the antenna structure 223. Finally, the fourth upper dielectric waveguide extends between the second dielectric feed (not illustrated) of the antenna structure 222 and the second dielectric feed (not illustrated) of the antenna structure 223. These upper dielectric waveguides couple to their respective dielectric feeds analogously as discussed for the first and second dielectric feeds 215 and 216.

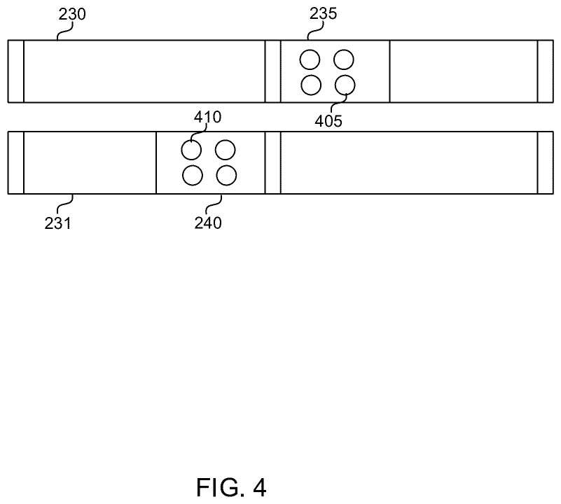

Referring again to FIG. 2, an upper surface of a first end of a first lower dielectric waveguide 230 couples to an approximate mid-point of a lower surface of the first upper dielectric waveguide 225. Similarly, an upper surface of a second end of the lower dielectric waveguide 230 couples to an approximate mid-point of a lower surface of the third upper dielectric waveguide 227. To assist the electromagnetic coupling to the respective upper waveguide, each end of the first lower dielectric waveguide 230 is beveled so as to extend from a lower surface of the first lower dielectric waveguide 230 to an upper surface of the first lower dielectric waveguide 230. Due to the side view of FIG. 2, the lower dielectric waveguide 230 shadows a second lower dielectric waveguide 231 (not illustrated in FIG. 2). A bottom view of the first and second lower dielectric waveguides 230 and 231 is shown in FIG. 4. The second lower waveguide 231 couples to the second upper waveguide 226 and to the fourth upper waveguide analogously to the coupling of the first lower waveguide 230 to the first upper waveguide 225 and the third upper waveguide 227. In addition, the electromagnetic coupling as well as mechanical fastening between each end of each lower waveguide and the corresponding upper waveguide may be assisted through a projection (not illustrated) that projects from the lower waveguide into the upper waveguide. A longitudinal gap separates the first and second lower waveguides 230 and 231. An analogous longitudinal gap separates the first and second upper waveguides 225 and 226. Similarly, an analogous longitudinal gap separates the third upper waveguide 227 and the fourth upper waveguide. Another analogous longitudinal gap may be provided between the pair of dielectric feeds to each antenna.

As seen in FIGS. 2 and 4, a first resonator structure 235 of four dielectric resonators such as formed by four cylindrical dielectric resonators 405 couples to a lower surface of the first lower dielectric waveguide 230 (e.g., to an approximate mid-point of the lower surface). This coupling thus functions as an input port to the first lower dielectric waveguide 230. Similarly, a second resonator structure 240 of four dielectric resonators such as formed by four cylindrical resonators 410 couples to a lower surface (e.g., to an approximate mid-point of the lower surface) of the second lower dielectric waveguide 231 that also functions as an input port. In alternative implementations, the number of resonators 405 and 410 may be less than or greater than four. Any suitable transmission line may be used to couple the first resonator structure 235 and the second resonator 240 to the radio layer of an RF front end of a corresponding transceiver (e.g., a MMIMO base station). For example, a coaxial connector 236 receives a coaxial cable (not illustrated) to couple to the first resonator structure 235. Similarly, a coaxial connector 241 receives a coaxial cable (not illustrated) to couple to the second resonator structure 240.

The first four dielectric resonators 405 introduce four poles in the frequency response of the filtering by the filtenna 200 for a first polarization. During a transmit mode of operation, a transceiver (not illustrated) drives a first RF transmit signal through the coaxial connector 236 into the four dielectric resonators 405. From the resonators 405, the first RF transmit signal couples through the first lower dielectric waveguide 230 to the first and third upper dielectric waveguides 225 and 227. The first upper dielectric waveguide 225 drives the antenna structures 220 and 221 to transmit according to the first linear polarization. The third dielectric waveguide 227 drives the antenna structures 222 and 223 to transmit according to the first linear polarization. A receive mode of operation for the first polarization would be analogous but in the opposite direction. Similarly, the transceiver during the transmit mode of operation may drive a second RF transmit signal through the coaxial connector 241 into the four dielectric resonators 410. The first four dielectric resonators 405 introduce four poles in the frequency response of the filtering by the filtenna 200 for a second linear polarization that is orthogonal to the first linear polarization. From the resonators 410, the second RF transmit signal couples through the second lower dielectric waveguide 231 to the second upper dielectric waveguide 231 and to the fourth upper dielectric waveguide. The second upper dielectric waveguide 231 drives the antenna structures 220 and 221 to transmit according to the second polarization. The fourth dielectric waveguide drives the antenna structures 222 and 223 to transmit according to the second polarization. A receive mode of operation for the second polarization would be analogous but in the opposite direction.

The resulting filtenna 200 provides a number of advantages, including reduced combining loss, reduced impedance mismatch loss, and no transition loss between the filtering and the radiation. These advantages are provided in part by the plurality of dielectric resonators 405 or 410 at an input/output port to a dielectric waveguide network formed by the (lower and upper) dielectric waveguides that feed a plurality of antennas. Although it is advantageous to form the antennas as rectangular dielectric resonator antennas, other types of antennas such as patch or dipole antennas may be used in conjunction with the dielectric waveguides. Regardless of the type of antennas used, the combination of the antennas and the dielectric waveguide network are configured to provide the final pole in the filter frequency response, for example based on a size, shape, material, dielectric properties, etc of the antennas and/or waveguide network. As noted earlier, the plurality of dielectric resonators at the input/output port may comprise four resonators such that the final pole is a fifth pole. More generally, the final pole is an nth pole in the frequency response, where n is plural integer and the number of dielectric resonators at each input/output port would be n−1 (each dielectric resonator providing one pole in the filter frequency response).

The dimensions of each rectangular dielectric resonator antenna and the separation between adjacent ones of the rectangular dielectric resonator antennas depend upon the desired frequency band and the desired bandwidth. The following discussion will be directed to an implementation for a mid-band frequency of 13 GHZ, but it will be appreciated that higher or lower frequencies may be used. At 13 GHZ, one-half of the wavelength is approximately 11.54 mm. A separation between the adjacent ones of the rectangular dielectric resonator antennas 205 (e.g., as measured from a center of each antenna) may thus be approximately 15 mm for operation at 13 GHz. A width across the dielectric waveguides (and across each antenna) such as the waveguides 225 and 226 may be approximately 11.5 mm. Any suitable dielectric may be used to form the upper and lower dielectric waveguides and also the resonators 410 and 405. In one implementation, the resonators 405 and 410 may be formed from a first ceramic (e.g., such as having a dielectric constant of approximately 21) whereas the upper and lower waveguides and the antenna structures may be formed from a second ceramic (e.g., such as having a dielectric constant of approximately 9.6).

Two layers of waveguides (an upper dielectric waveguide layer and a lower dielectric waveguide layer) are illustrated and described in the examples above. A great or fewer layers of waveguides may be implemented, for example based on the number of antennas implemented in the array. In some examples, a single waveguide layer is implemented for a two antenna array and three waveguide layers are implemented for an eight antenna array.

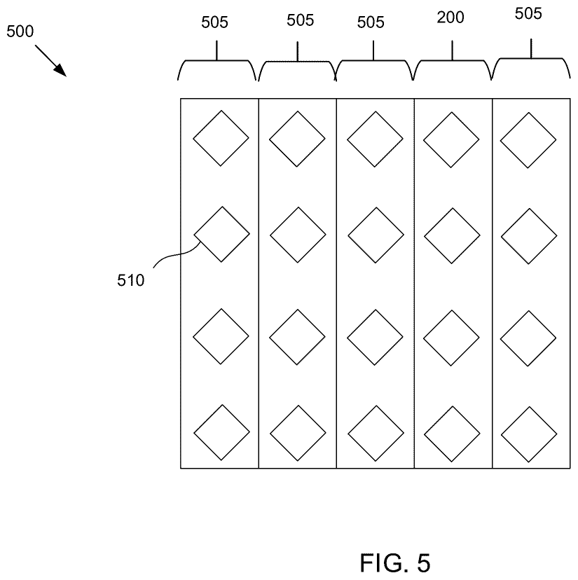

A filtenna 505 may be repeated to form an integrated antenna-array-and-filter structure 500 as shown in a top view of FIG. 5. In structure 500, the filtenna 505 is repeated five times to form a 4×5 array of twenty dielectric resonator antennas 510. The design of such a structure 500 of a plurality of filtennas 505 is advantageously eased in that each filtenna 505 has its own filtering and can be directly connected to the radio layer of the corresponding transceiver (e.g., a MMIMO base station) such as through the connectors 236 and 241 discussed with respect to FIG. 2. An example wireless transceiver incorporating a filtenna as disclosed herein will now be discussed.

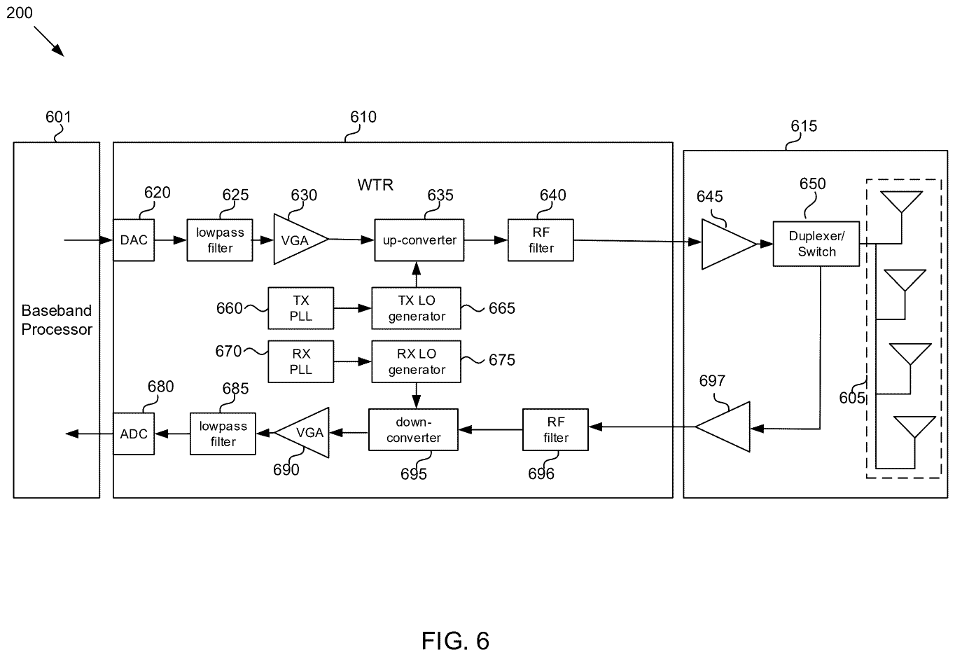

A wireless transceiver 600 such as a MMIMO base station with a filtenna 605 is shown in more detail in FIG. 6. A baseband processor (modern) 601 includes at generates a digital baseband signal that is converted by a digital-to-analog converter (DAC) 620 in a wireless transceiver integrated circuit (WTR) 610 into an analog baseband transmit signal for an at least one transmit path. A lowpass filter 625 filters the analog baseband transmit signal to provide a filtered analog signal to a variable gain amplifier (VGA) 630. An up-converter 635 (such as one or more mixers) up-converts an amplified analog baseband signal from the VGA 630 in frequency to produce an RF signal. For example, the up-converter 635 may mix the amplified analog baseband signal with a local oscillator (LO) signal from a transmit (TX) LO generator 665. An oscillator such as a TX phase-locked loop (PLL) 660 clocks the TX LO generator 665 for the generation of the TX LO signal. An RF filter 640 filters the RF signal from the up-converter 635 to produce an RF input signal.

A front-end module 615 includes a power amplifier 645 for amplifying the RF input signal. It will be appreciated that additional stages of amplification of the RF input signal prior to the power amplifier 645 such as a pre-driver amplifier (not illustrated) and a driver amplifier (not illustrated) may also be used in alternative implementations. The power amplifier 645 may be a Doherty amplifier in some implementations. An amplified RF output signal from the power amplifier 645 passes through an antenna module (e.g., a duplexer for FDD operation or a switch for TDD operation) 650 to the filtenna 605 for wireless transmission.

During a receive mode, a received RF signal from the filtenna 605 passes through the antenna module 650 to a low-noise amplifier 697. The WTR 610 also includes an RF filter 696 for filtering an amplified RF receive signal from the LNA 697. A down-converter 695 (such as one or more mixers) down converts the filtered RF signal from the RF filter 696 in frequency to produce a down-converted analog signal. For example, the down-converter 695 may mix the filtered RF signal with an LO signal from a receive (RX) LO generator 675. An oscillator such as an RX phase-locked loop (PLL) 670 clocks the RX LO generator 675 for the generation of the RX LO signal. Another VGA 690 amplifies the down-converted analog signal from the down-converter 695 to drive a lowpass filter 685 that provides a filtered analog baseband signal to an analog-to-digital (ADC) 680 to provide a digital baseband received signal to the baseband processor 601. It will be appreciated that the WTR 610 and the RF front end 615 are merely exemplary and that other transceiver architectures may be used in conjunction with the self-interference mitigation disclosed herein.

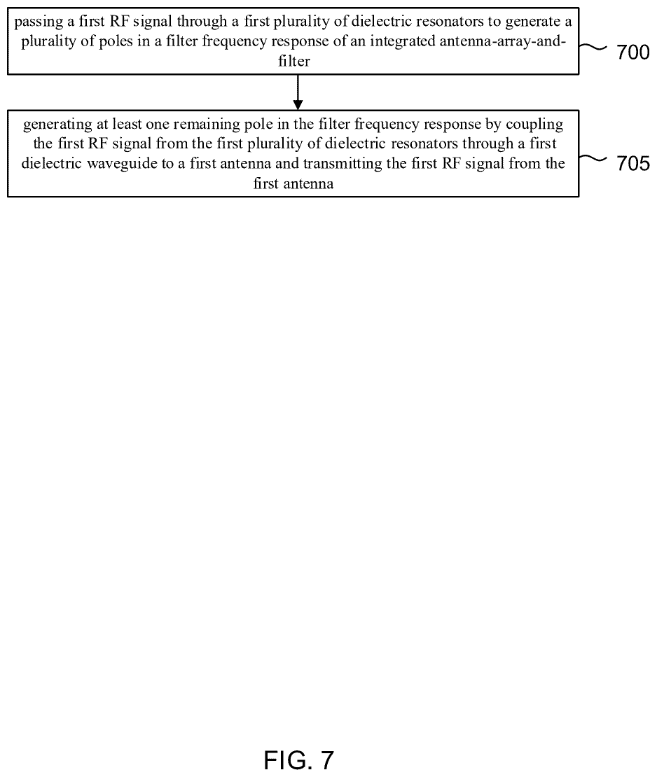

An example method of transmitting through a filtenna will now be discussed with regard to the flowchart of FIG. 7. The method includes an act 700 of passing a first RF signal through a first plurality of dielectric resonators to generate a plurality of poles in a filter frequency response of an integrated antenna-array-and-filter. The resonant processing by the dielectric resonators 405 or 410 is an example of act 700. In addition, the method includes an act 705 of generating at least one remaining pole in the filter frequency response by coupling the first RF signal from the first plurality of dielectric resonators through a first dielectric waveguide to a first antenna and transmitting the first RF signal from the first antenna. The transmission of an RF signal from the plurality of dielectric resonators 405 or 410 through the dielectric waveguide network formed by the upper and lower dielectric waveguides to the corresponding antenna structures is an example of act 705.

Some example implementations will now be summarized through the following numbered clauses:

Clause 1. An integrated antenna-array-and-filter, comprising:
a dielectric waveguide network;
a first plurality of dielectric resonators coupled to a dielectric waveguide network; and
a plurality of antennas coupled to the dielectric waveguide network, wherein the dielectric waveguide network and the plurality of antennas are configured to function as a resonator providing at least one pole in a filter frequency response of the integrated antenna-array-and-filter, and wherein the first plurality of dielectric resonators is configured to provide a remaining plurality of poles in the filter frequency response.
   Clause 2. The integrated antenna-array-and-filter of clause 1, wherein the first plurality of dielectric resonators comprises a first plurality of four cylindrical dielectric resonators, and wherein the remaining plurality of poles comprises five poles.
   Clause 3. The integrated antenna-array-and-filter of clause 2, wherein the four cylindrical dielectric resonators comprise four cylindrical resonators.
   Clause 4. The integrated antenna-array-and-filter of any of clauses 1-3, further comprising:
a first coaxial connector coupled to the first plurality of dielectric resonators.
   Clause 5. The integrated antenna-array-and-filter of any of clauses 1-4, wherein the plurality of antennas includes a first rectangular dielectric resonator antenna and a second rectangular dielectric resonator antenna.
   Clause 6. The integrated antenna-array-and-filter of clause 5, wherein the dielectric waveguide network comprises:
a first lower dielectric waveguide extending from a first end to a second end, wherein the first plurality of dielectric resonators is coupled to a lower surface of the first lower dielectric waveguide;
a first upper dielectric waveguide extending from a first end to a second end, wherein the first end of the first lower dielectric waveguide is coupled to a lower surface of the first upper dielectric waveguide;
a first dielectric feed coupled between the first end of the first upper dielectric waveguide and a first planar face of the first rectangular dielectric resonator antenna; and
a second dielectric feed coupled between the second end of the first upper dielectric waveguide and a first planar face of the second rectangular dielectric resonator antenna.
   Clause 7. The integrated antenna-array-and-filter of clause 6, further comprising:
a second plurality of dielectric resonators;
a second lower dielectric waveguide extending from a first end to a second end, wherein the second plurality of dielectric resonators is coupled to a lower surface of the first lower dielectric waveguide;
a second upper dielectric waveguide extending from a first end to a second end, wherein the first end of the second lower dielectric waveguide is coupled to a lower surface of the second upper dielectric waveguide;
a third dielectric feed coupled between the first end of the second upper dielectric waveguide and a second planar face of the first rectangular dielectric resonator antenna; and
a fourth dielectric feed coupled between the second end of the second upper dielectric waveguide and a second planar face of the second rectangular dielectric resonator antenna.
   Clause 8. The integrated antenna-array-and-filter of clause 7, wherein the first lower dielectric waveguide, the second lower dielectric waveguide, the first upper dielectric waveguide, and the second upper dielectric waveguide each comprises a rectangular dielectric waveguide.
   Clause 9. The integrated antenna-array-and-filter of clause 7, wherein the plurality of antennas further includes a third rectangular dielectric resonator antenna and a fourth rectangular dielectric resonator antenna.
   Clause 10. The integrated antenna-array-and-filter of clause 7, further comprising: a first dielectric base plate coupled between an upper surface of the first upper dielectric waveguide and a lower surface of the first rectangular dielectric resonator antenna; and a second dielectric base plate coupled between an upper surface of the second upper dielectric waveguide and a lower surface of the second rectangular dielectric resonator antenna.
   Clause 11. The integrated antenna-array-and-filter of any of clauses 1-10, wherein the dielectric waveguide network, the first plurality of dielectric resonators coupled to an input port of the dielectric waveguide network, and the plurality of antennas are configured such that the filter frequency response is a bandpass response.
   Clause 12. A method of transmitting, comprising:
passing a first RF signal through a first plurality of dielectric resonators to generate a plurality of poles in a filter frequency response of an integrated antenna-array-and-filter; and
generating at least one remaining pole in the filter frequency response by coupling the first RF signal from the first plurality of dielectric resonators through a first dielectric waveguide to a first antenna and transmitting the first RF signal from the first antenna.
   Clause 13. The method of clause 12, wherein passing the first RF signal through the first plurality of dielectric resonators comprises passing the first RF signal through a plurality of cylindrical dielectric resonators.
   Clause 14. The method of any of clauses 12-13, wherein coupling the first RF signal through the first dielectric waveguide comprises coupling the first RF signal through a first rectangular dielectric waveguide.
   Clause 15. The method of clause 14, wherein the first antenna is a first rectangular dielectric resonator antenna, the method further comprising:
   coupling the first RF signal through a first dielectric feed to a first planar face of the first rectangular dielectric resonator antenna to transmit the first RF signal according to a first linear polarization.
   Clause 16. The method of clause 15, further comprising:
passing a second RF signal through a second plurality of dielectric resonators; and
propagating the second RF signal from the second plurality of dielectric resonators through a second rectangular dielectric waveguide; and
coupling the second RF signal through a second dielectric feed to a second planar face of the first rectangular dielectric resonator antenna to transmit the second RF signal according to a second linear polarization that is orthogonal to the first linear polarization.
   Clause 17. An integrated antenna-array-and-filter, comprising:
a plurality of dielectric resonators;
a first antenna; and
a dielectric waveguide coupled between the plurality of dielectric resonators and the first antenna.
   Clause 18. The integrated antenna-array-and-filter of clause 17, further comprising:
a second antenna, wherein the dielectric waveguide comprises a lower dielectric waveguide coupled to the plurality of dielectric resonators and a second dielectric waveguide having a first end coupled to the first antenna and a second end coupled to the second antenna.
   Clause 19. The integrated antenna-array-and-filter of clause 18, wherein the lower dielectric waveguide and an upper dielectric waveguide each comprises a rectangular dielectric waveguide, and wherein the first antenna and the second antenna each comprises a dielectric resonator antenna.
   Clause 20. The integrated antenna-array-and-filter of clause 19, wherein the integrated antenna-array-and-filter is included within a base station.

As those of some skill in this art will by now appreciate and depending on the particular application at hand, many modifications, substitutions and variations can be made in and to the materials, apparatus, configurations and methods of use of the devices of the present disclosure without departing from the scope thereof as defined by the appended claims. In light of this, the scope of the present disclosure should not be limited to that of the particular implementations illustrated and described herein, as they are merely by way of some examples thereof, but rather, should be fully commensurate with that of the claims appended hereafter and their functional equivalents.

What is claimed is:

1. An integrated antenna-array-and-filter, comprising:
a dielectric waveguide network;
a first plurality of dielectric resonators coupled to a dielectric waveguide network; and
a plurality of antennas coupled to the dielectric waveguide network, wherein the dielectric waveguide network and the plurality of antennas are configured to function as a resonator providing at least one pole in a filter frequency response of the integrated antenna-array-and-filter, and wherein the first plurality of dielectric resonators is configured to provide a remaining plurality of poles in the filter frequency response.

2. The integrated antenna-array-and-filter of claim 1, wherein the first plurality of dielectric resonators comprises a first plurality of four cylindrical dielectric resonators, and wherein the remaining plurality of poles comprises five poles.

3. The integrated antenna-array-and-filter of claim 2, wherein the four cylindrical dielectric resonators comprise four ceramic resonators.

4. The integrated antenna-array-and-filter of claim 1, further comprising:
a first coaxial connector coupled to the first plurality of dielectric resonators.

5. The integrated antenna-array-and-filter of claim 1, wherein the plurality of antennas includes a first dielectric resonator antenna and a second dielectric resonator antenna.

6. The integrated antenna-array-and-filter of claim 5, wherein the dielectric waveguide network comprises:
a first lower dielectric waveguide extending from a first end to a second end, wherein the first plurality of dielectric resonators is coupled to a lower surface of the first lower dielectric waveguide;
a first upper dielectric waveguide extending from a first end to a second end, wherein the first end of the first lower dielectric waveguide is coupled to a lower surface of the first upper dielectric waveguide;
a first dielectric feed coupled between the first end of the first upper dielectric waveguide and a first planar face of the first rectangular dielectric resonator antenna; and
a second dielectric feed coupled between the second end of the first upper dielectric waveguide and a first planar face of the second rectangular dielectric resonator antenna.

7. The integrated antenna-array-and-filter of claim 6, further comprising:
a second plurality of dielectric resonators;
a second lower dielectric waveguide extending from a first end to a second end, wherein the second plurality of dielectric resonators is coupled to a lower surface of the first lower dielectric waveguide;
a second upper dielectric waveguide extending from a first end to a second end, wherein the first end of the second lower dielectric waveguide is coupled to a lower surface of the second upper dielectric waveguide;
a third dielectric feed coupled between the first end of the second upper dielectric waveguide and a second planar face of the first rectangular dielectric resonator antenna; and
a fourth dielectric feed coupled between the second end of the second upper dielectric waveguide and a second planar face of the second rectangular dielectric resonator antenna.

8. The integrated antenna-array-and-filter of claim 7, wherein the first lower dielectric waveguide, the second lower dielectric waveguide, the first upper dielectric waveguide, and the second upper dielectric waveguide each comprises a rectangular dielectric waveguide.

9. The integrated antenna-array-and-filter of claim 7, wherein the plurality of antennas further includes a third rectangular dielectric resonator antenna and a fourth rectangular dielectric resonator antenna.

10. The integrated antenna-array-and-filter of claim 7, further comprising:
a first dielectric base plate coupled between an upper surface of the first upper dielectric waveguide and a lower surface of the first rectangular dielectric resonator antenna; and
a second dielectric base plate coupled between an upper surface of the second upper dielectric waveguide and a lower surface of the second rectangular dielectric resonator antenna.

11. The integrated antenna-array-and-filter of claim 1, wherein the dielectric waveguide network, the first plurality of dielectric resonators coupled to an input port of the dielectric waveguide network, and the plurality of antennas are configured such that the filter frequency response is a bandpass response.

12. A method of transmitting, comprising:
passing a first RF signal through a first plurality of dielectric resonators to generate a plurality of poles in a filter frequency response of an integrated antenna-array-and-filter; and
generating a remaining pole in the filter frequency response by coupling the first RF signal from the first plurality of dielectric resonators through a first dielectric waveguide to a first antenna and transmitting the first RF signal from the first antenna.

13. The method of claim 12, wherein passing the first RF signal through the first plurality of dielectric resonators comprises passing the first RF signal through a plurality of cylindrical dielectric resonators.

14. The method of claim 12, wherein coupling the first RF signal through the first dielectric waveguide comprises coupling the first RF signal through a first rectangular dielectric waveguide.

15. The method of claim 14, wherein the first antenna is a first rectangular dielectric resonator antenna, the method further comprising:
coupling the first RF signal through a first dielectric feed to a first planar face of the first rectangular dielectric resonator antenna to transmit the first RF signal according to a first linear polarization.

16. The method of claim 15, further comprising:
passing a second RF signal through a second plurality of dielectric resonators; and
propagating the second RF signal from the second plurality of dielectric resonators through a second rectangular dielectric waveguide; and
coupling the second RF signal through a second dielectric feed to a second planar face of the first rectangular dielectric resonator antenna to transmit the second RF signal according to a second linear polarization that is orthogonal to the first linear polarization.

17. An integrated antenna-array-and-filter, comprising:
a plurality of dielectric resonators;
a first antenna; and
a dielectric waveguide coupled between the plurality of dielectric resonators and the first antenna.

18. The integrated antenna-array-and-filter of claim 17, further comprising:
a second antenna, wherein the dielectric waveguide comprises a lower dielectric waveguide coupled to the plurality of dielectric resonators and a second dielectric waveguide having a first end coupled to the first antenna and a second end coupled to the second antenna.

19. The integrated antenna-array-and-filter of claim 18, wherein the lower dielectric waveguide and an upper dielectric waveguide each comprises a rectangular dielectric waveguide, and wherein the first antenna and the second antenna each comprises a dielectric resonator antenna.

20. The integrated antenna-array-and-filter of claim 19, wherein the integrated antenna-array-and-filter is included within a base station.
